(19) United States
(12) Patent Application Publication
(10) Pub. No.: US 2012/0297558 A1
(43) Pub. Date: Nov. 29, 2012

(54) ARCHED LOADING RAMP

(76) Inventors: Ying WANG, Nanjing (CN); Ning Yang, Nanjing (CN); Pengsheng Ji, Nanjing (CN)

(21) Appl. No.: 13/118,439

(22) Filed: May 29, 2011

(51) Int. Cl. B65G 69/30; B23P 13/00

(52) U.S. Cl. 14/69.5; 72/324

(57) ABSTRACT

A dual traction cutout ramp having a top surface and a back surface, and having plurality of apertures punched through the top and the back surfaces in alternative forming protrusions and indentations throughout the surface of the ramp. This dual traction cutout ramp can remove mud and dirt from the wheels of vehicles that move onto the ramp.

### BACKGROUND OF THE INVENTION

1. Field of the Invention

The present invention relates to ramps for moving smaller vehicles or cargo into or out of a pickup truck, utility vehicle, or other platforms, wherein the ramp having anti-skid and mud, dirt and debris removing capabilities.

2. Description of the Related Art

Ramps are used in trucks, and other vehicles having a platform above the ground, to move any load or shipment in and out of the vehicle. Ramps are also used to move another vehicle, such as a motorcycles, snowmobiles, wheelbarrow, and barrels into the back of a truck.

There are numerous ramp designs, including single section straight and arched ramps, as well as foldable straight and arched ramps. Single section nonfoldable ramps are used in more permanent applications, whereas foldable ramps can be stored inside a truck and transported easily. Since ramps are usually used to move relatively heavy loads, such as a motorcycle or another vehicle, they have to be sturdy. Therefore, most industrial ramps are made of steel and transportable ramps are made of extruded aluminum profiles. This makes the ramp relatively heavy. However, it is desirable to have a sturdy but a light weight ramp so that it can be easily moved.

One of the common uses of a ramp is in moving motorcycles, dirt bikes and other recreational vehicles used in open fields. In such cases, vehicle tires may have mud and dirt on them and may carry the mud into the truck. It is desirable to have a ramp that can remove or reduce the amount of mud and dirt on the tires of the vehicle as it is being moved onto the ramp. One object of the present ramp is to remove or reduce the amount of the mud from muddy tires.

### SUMMARY OF THE INVENTION

Embodiments herein provide a dual traction cutout ramp for moving cargo on vehicles. In accordance with an embodiment herein, the ramp has punched holes throughout its surface. The holes are punched alternatively in opposite directions, forming protrusions and cavities, thus forming a dual traction cutout ramp. The dual traction cutout ramp not only makes the ramp structurally strong, it helps to remove the mud and dirt from the tires of vehicles moving up the ramp. The ramp may be in one section or two elongated sections pivotably connected to each other. One end of the ramp is set on a vehicle or any platform, and its other end is positioned on the ground. The two sections of the ramp can be folded for easy storage. The dual traction cutout has the following advantages and solves the following problems: Cutout from bottom to top provides excellent anti-skid traction. And the cutouts from the top to bottom help the mud to remove faster. In addition, the dual traction cutouts add strength to the sheet aluminum material.

In accordance with an embodiment herein, the ramp is arched to allow easy movement onto the vehicle. The lower edges of the ramp have reinforcement to prevent any damage to the ramp during the loading. Vious components of the ramp are made from a light weight material, such as aluminum, plastic, fiberglass, or similar materials. This makes the ramp light in weight, and therefore, easy to use and carry. In addition, the reinforcement may, for example, be made from at least one of plastic, fiber glass, wood, and metal and also with dipped or coated material to protect the tailgate

### OBJECTS OF THE INVENTION

An object of the present invention is to provide a dual traction cutout ramp to load cargo onto the back of a vehicle or other platforms. Another object of the present invention is to provide a ramp which is anti-skid and has enough traction that motor vehicles and other cargo can be moved up the ramp without skidding. Yet another object of the present invention is to provide a ramp that can remove mud and dirt from the wheels of the vehicles that are moving onto the ramp. Yet another object of the present invention is to have a sturdy ramp from a light weight material such as aluminum. Another object of the present invention is to provide a ramp that can be folded for easy transport. Other objects, advantages and novel features of the present invention will become apparent from the following description of the preferred embodiments when considered in conjunction with the accompanying drawings.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 illustrates (a) a straight nonfolding ramp; (b) an arched folding ramp; and (c) a straight folding ramp.

FIG. 2 illustrates a perspective view of a folded arched ramp;

FIG. 3 illustrates the exploded view of a the end sections of the ramp;

FIG. 4 illustrates the exploded view of alternatively upwardly and downwardly cutout ramp;

FIG. 5 is a schematic representation of mud removal from the tires of a vehicle while moving along the ramp;

FIG. 6 illustrates a perspective view of a foldable curved ramp used in conjunction with a pickup truck while loading a motorcycle; and

FIG. 7 illustrates the pre-folded metal sheet section punched and cut to form an arched ramp.

### DESCRIPTION OF THE PREFERRED EMBODIMENTS

Ramps are needed to move load from ground level onto a truck. Ramps are also used to load and unload goods from one level to another level, for instance from ground onto a loading dock. Vehicles which frequently are used for loading and unloading, need to have a portable ramp onboard. Such ramps need to be easily stored inside the vehicle. Therefore, they should be compact and may be foldable as well as being light weight.

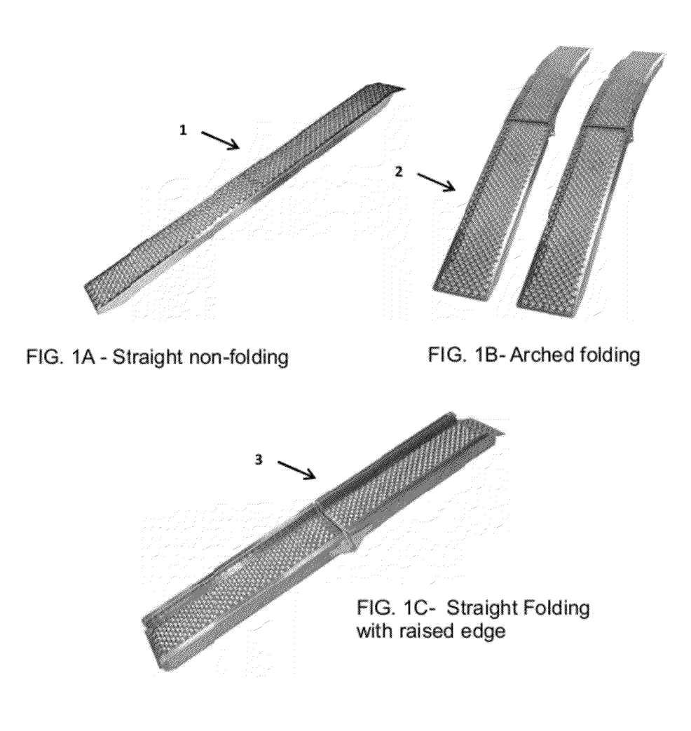

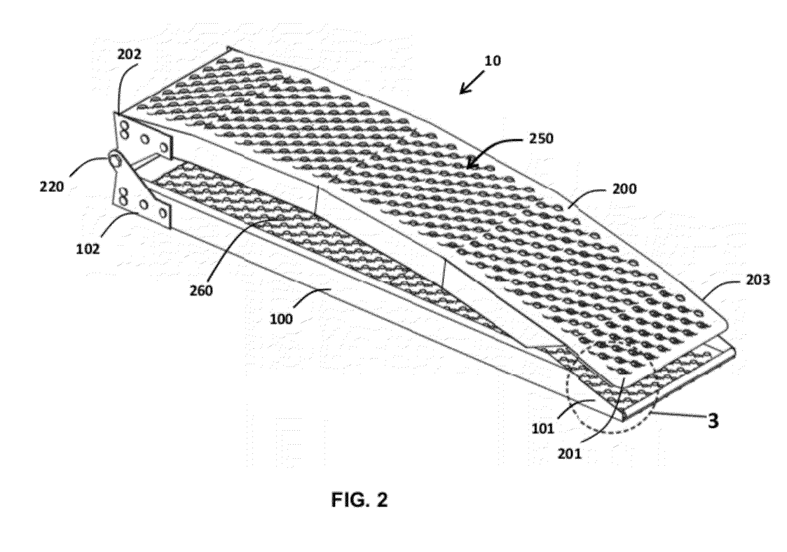

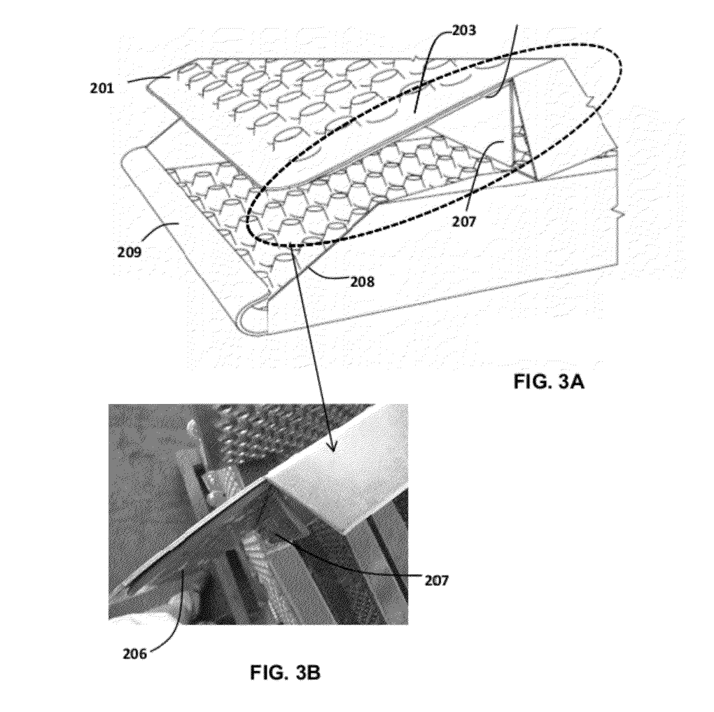

Ramps are generally in four different designs: straight unfolding and folding ramps, and arched unfolding and folding ramps. FIG. 1 illustrates three different types of ramps: (a) a straight nonfolding ramp 1; (b) an arched folding ramp 2; and (c) a straight folding ramp 3. Nonfolding ramps normally provide larger capacity than folding ramps and have lower cost. Other ramp designs can also be considered. Details of the structure of the presently disclosed ramps are illustrated in FIG. 2 for a folding arched ramp. Ramp 10 comprises of two sections, 100 and 200. The two sections are hinged together at one end 220. The first ramp section 100 has a ground engaging section, 101 and a coupling section 102. Similarly, the second ramp section, 200, has an “attaching lip”, 201 to engage to a vehicle, and a coupling section, 202. The attaching lip is where the ramp connects on the tailgate of a truck/van/trailer or any other platform. During loading and unloading, this part has to bear a lot of pressure. Again, as sheet aluminum material is used to make the ramp, one single layer of the sheet aluminum may not be strong enough to hold the loaded vehicle or equipment. So an additional plate is used onto the bottom of the plate on the ramp itself to make this ramp a lot stronger. The attaching lip can have different designs for different ramps. In the presently disclosed ramp, a single reinforcement plate 206 is used under the lip 201 of the ramp, as illustrated in FIG. 3. The reinforced plate may have the same material as the dual traction cutouts. The reinforced plates are dipped coated. The reinforced plate is riveted to the ramp lip.

For the arched folding version, due to the arched design, when the ATV's or the lawn tractors start to get onto the ramp, the ramp might be pushed onto the tailgate. Therefore, a “L” shaped kick stopper 207 is added on the reinforced plate. The purpose of this kick stop is to prevent the ramp from moving forward during the process of loading. The “L” shaped kick stopper is also dipped coated. The ground engaging section 101 sits on the ground. The vehicle engaging section 201 has a transition section 203 on top to smoothly transfer load onto the vehicle. The ground engaging end has two features: Diagonal cut with an angle 208. This angle is calculated according to the angle formed by the length of the ramp and the standard truck bed height. The purpose of the angle cut is to make a good match with the ramp bottom edge and the ground so there is as little gap in between as possible. The edge 209 is folded for strength as well as easy transfer of a vehicle onto the ramp. The ramp can have any size, preferably 48″-108″ unfolded length and 8″-26″ in width.

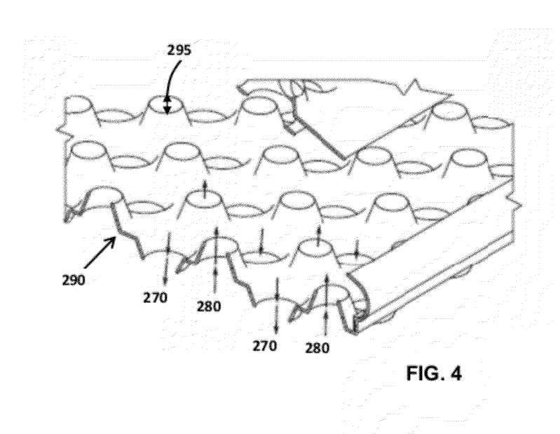

The main element of the presently disclosed ramp is its structural design as illustrated in FIG. 4. The ramp has “Dual Traction Cutouts”. For this purpose, an elongated section of sheet aluminum is used and a series of holes are punched alternatively in two directions, one from its top 250 and one from its bottom 260 surfaces. Holes punched from the bottom surface form protrusions 270 on the top surface and holes punched from the top surface form cavities 280 on the top surface. This method of punching the aluminum sheet forms bent cross section 290 throughout the aluminum sheet that makes the ramp very sturdy, even if a relatively thin aluminum sheet is used. The sheet thickness may vary, but preferable sheet thickness is between 1 mm-5 mm range.

The diameters of the punched holes 295 may be all the same size or have different sizes. For instance, the holes close to the bottom of the ramp can be larger to remove more dirt, and the ones closer to the top of the ramp can be smaller, since most dirt is already removed. The preferable hole diameters are 13 mm for holes punched from bottom to top and 8 mm for holes punched from top to bottom. Punched holes can also be circular, rectangular, triangular, star or any other shape. In addition, spacings between two neighboring holes may vary. The preferred spacing between the neighboring holes is between 1/16″ to ½″.

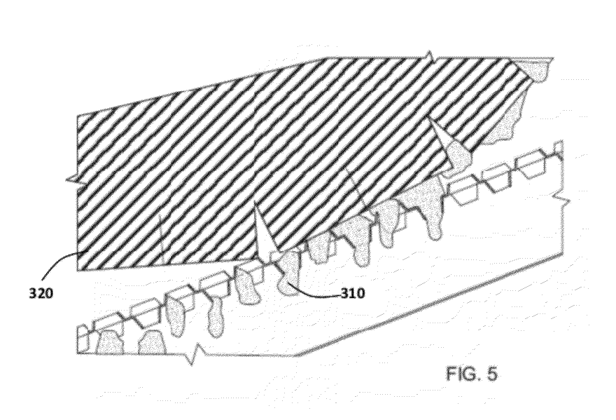

FIG. 5 illustrates how mud and dirt 310 is removed from the tire 320 of a vehicle as it is moved on the ramp. The mud is squeezed into the ramp cavities and sheared off the tires, reducing the amount of mud on the tire.

In order to keep the weight of the ramp low, the ramp is made of a light weight stiff material, preferably Aluminum Magnesium Alloy. The presently disclosed ramp is made of sheet aluminum. This is different than the prior art ramps which use extruded aluminum. Standard aluminum sheets cannot bear such heavy load as the presently disclosed ramp. One embodiment of the present ramp can have a 750 lb capacity by making the ramp from aluminum magnesium alloy (preferably code 5000) which is more tensile than standard aluminum (code 6061). In addition, using the dual traction cutout not only makes the dirt flow away quicker, but also adds strength to the ramp panel.

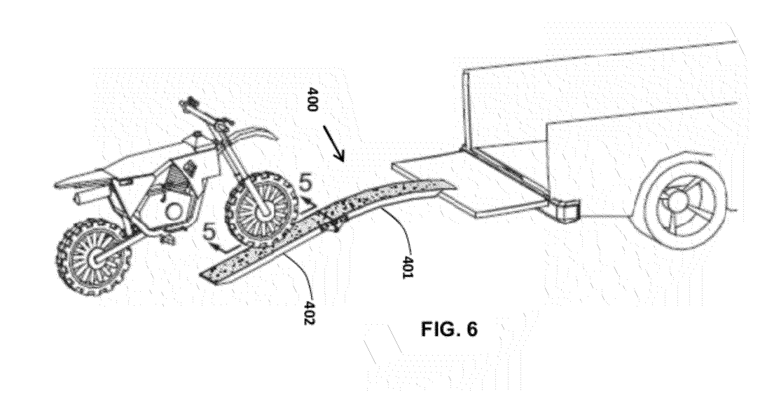

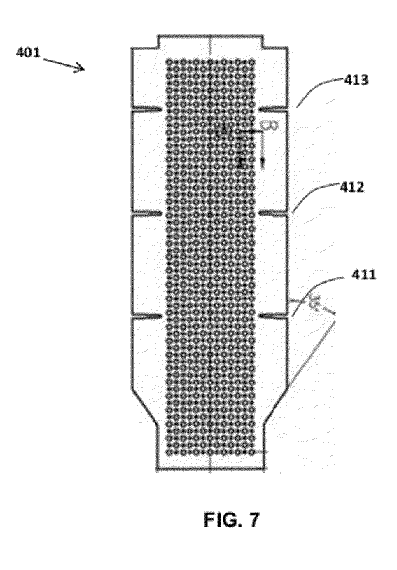

An arched folding ramp 400 is illustrated in FIG. 6, which has an arched section 401, and a straight section 402. The method of making the arched ramp section is illustrated in FIG. 7. An elongated metal sheet is cut to size. The holes are punched on the central section of the sheet. The width of the section that has holes is the width of the ramp. The rest of the width of the sheet does not have any holes. To form the arched ramp, several tapered cuts are made along the side of the ramp. The sides of the metal sheet are then bent by 90 degrees downwardly to form the vertical sides of the ramp. The metal sheet is then arched along its length. The tapered angle of the side cuts are designed so that the edges of the cut reach each other once the ramp is arched along its length. The cuts are then welded to form the arched ramp.

This application may disclose several numerical range limitations that support any range within the disclosed numerical ranges even though a precise range limitation is not stated verbatim in the specification because the embodiments of the invention could be practiced throughout the disclosed numerical ranges. Finally, the entire disclosure of the patents and publications referred in this application, if any, are hereby incorporated herein in entirety by reference.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Obviously, many modifications and variations of the present invention are possible in light of the above teachings. It is therefore to be understood that, within the scope of the appended claims, the invention may be practiced otherwise than as specifically described.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17- A dual traction cutout vehicle ramp comprising:
a. an elongated single sheet of aluminum cut to a desired width and length, having
b. a top surface and a bottom surface, a first end and a second end, said first end being a ground engaging section, said second end being an attaching lip to engage to a vehicle,
c. said aluminum sheet having a central section with multiplicity of apertures,
d. said aluminum sheet having a right edge and a left edge along the central section having no apertures, said edges having a width,
e. multiplicity of tapered cuts on the edges wherein said cuts extend only through the width of the edges, said edges having a 90 degree bend with respect to the surface of the sheet,
f. said tapered cuts being welded to form a structurally sturdy ramp;
g. said aperture on the platform being punched through the sheet alternatively downwardly from the top surface and upwardly from the bottom surface, wherein upwardly punched apertures from the bottom surface form protrusions on the top surface and downwardly punched apertures from the top surface form cavities on the top surface, whereby said alternatingly upward and downwardly punched apertures form multiplicity of curvatures on said aluminum sheet,
h. an anti-skid plate attached under said attaching lip, and
i. a L shaped kick stopper attached under said attaching lip to prevent the ramp from moving forward during the process of loading,
whereby said ramp being made of only one sheet of aluminum and being lightweight and sturdy.
